(19) United States
(12) Patent Application Publication
(10) Pub. No.: US 2013/0144413 A1
(43) Pub. Date: Jun. 6, 2013

(54) COMPUTER-IMPLEMENTED METHOD AND SYSTEM FOR QUALITATIVE EVENT-BASED ANALYSIS

(71) Applicant: Bryan Jay Bain, Charleston, SC (US)

(72) Inventor: Bryan Jay Bain, Charleston, SC (US)

(73) Assignee: Real Sports Analytics, LLC, Charleston, SC (US)

(21) Appl. No.: 13/757,777

(22) Filed: Feb. 2, 2013

Related U.S. Application Data
(63) Continuation-in-part of application No. 12/399,336, filed on Mar. 6, 2009.

(51) Int. Cl. G06F 17/40

(52) U.S. Cl. CPC G06F 17/40
USPC 700/91

(57) ABSTRACT

A computer-implemented method and system to generate event-specific analyses of event-specific data by generating real-time aggregation algorithms based on continuously evolving qualitative parameters. An embodiment may generate trend analysis of large amounts of sporting event data and/or an analysis of player-based scoring for team and individual performance data, including trends over seasons, leagues, and/or games. The method and system may be continuously configured in response user definition and production of unique identifiers and metrics.

This is a continuation-in-part to co-pending U.S. patent application Ser. No. 12/399,336 by Bryan Bain, filed on Mar. 6, 2009 and entitled “Sport Analytics: Use of a Multidimensional Database Technology in the Analysis of Sports Metrics Related Data,” hereby incorporated in its entirety by reference.

### FIELD

The present invention relates to the field of computer systems, in particular, a computer-implemented method and system to generate event-specific analyses of event-specific data by generating dynamic combination and permutation algorithms based on continuously evolving qualitative parameters.

### BACKGROUND

The 21st century has seen an explosion of analytical technologies and methods proliferate in areas such as retail and sales analysis, supply chain, financial reporting and other areas where large data sets prevail. Performance management methodologies for other industries are nothing new and have become commonplace in the market. Currently, most corporations see these systems as necessary to compete in the global marketplace.

Essentially these models take large data sets (retail is a common, understandable example) and somehow compute usable information. A good example is retail point of sales (POS) information. Large retailers have hundreds of millions of transactions occur over the course of the year. From these hundreds of millions of rows of raw data the company must find a way to understand supply and demand, inventory planning, transportation, marketing, financial reporting and a myriad of other subject-matter based information in order to effectively run their company.

With the advent of multi-dimensional technology in the early 90's the analysis of these extremely large data sets became much easier. This technology is specifically designed to read these data sets and allow the systems to derive and users to extract vital, usable information.

The world of sports and sport management has also evolved in the last few years. Most upper level professional and college football games now employ instant replay technology based on advanced digital media. Basketball has used instant replay for even longer to assess the validity of last-second scoring. Baseball has long employed sophisticated database software to keep track of numerous base-level statistics.

From a true methodology perspective though, most sports are still in the “pencil and clipboard” stage. Player performance is noted during game time and during post-game film reviews. Some analysis is also performed and “scored”, but these methods are severely hampered by the current technology employed to understand this growing inventory of data. Scoring systems for sports analysis are varied not only from sport to sport, but also from team to team, thus making it difficult for anyone to develop a particular technology that can address these challenges.

Numerous innovations for analyzing data sets for sports and event-based statistics, and related systems, have been provided in the prior art that will be described infra. Some statistics have used player efficiency formulas, plus/minus indications of a player's contribution, or hot spots on a basketball court. Even though these innovations may be suitable for the specific individual purposes to which they address, however, they differ from the present invention in that they do not teach a system for expressing dynamic qualitative analysis configured to continuously evolving performance metrics across specified intersections and user requirements in athletic events.

For example, Pub. No US 2008/0086223 A1 to Pagliarulo published on Apr. 10, 2008, which is hereby incorporated by reference, teaches a system for evaluating a baseball player by combining data from a database and graphical evaluation tools of the player's performance. The system teaches recordation of quantitative pitch counts and pitch locations for a pitcher.

While these references provide a useful way to track and analyze large amounts of event-based data points, there are currently no references that support real-time qualitative analysis configured to continuously evolving performance metrics across specified intersections and user requirements in athletic events.

### SUMMARY

Embodiments described herein refer to generating dynamic qualitative analysis configured to continuously evolving performance metrics across specified intersections and user-requirements in athletic events. According to an embodiment, a computer-implemented method for expressing qualitative, dynamic event-based performance analysis comprises defining qualified system metrics, the qualified system metrics being stored in a multi-dimensional database and incorporated into a calculation algorithm executing on one or more microprocessors; inputting base level data into at least one input page using an input/output device, the base level data being stored in the multi-dimensional database; inputting weighting and comparison metrics, and quality control metrics, into at least one input page using an input/output device, the weighting and comparison metrics, and the quality control metrics being stored in the multi-dimensional database; aggregating the base level data and the weighting and comparison metrics and quality control metrics executing on the one or more microprocessors and in communication with the multi-dimensional database; and, calculating all combinations and permutations of the base level data and the weighting and comparison metrics and quality control metrics executing on the one or more microprocessors and in communication with the multi-dimensional database.

According to another embodiment, a system for generating qualitative event-based performance analysis comprises a system operator machine, the system operator machine being operable to generate and store qualitative event parameters in response to an end user request; a qualified observer machine, the qualified observer machine being operable to receive qualitative event parameters from the system operator machine over one or more network servers, and communicate base level data to the system operator machine through the one or more network servers; and, a client machine, the client machine being operable to communicate qualitative variables and display variables to the system operator machine over the one or more network servers.

According to another embodiment, a system for generating qualitative analysis of athletic events comprises a system operator machine, the system operator machine operable to execute event-specific program logic on one or more microprocessors; a qualified observer machine, the qualified observer machine operable to input base level data according to predetermined parameters over one or more network servers to a multi-dimensional database; and, a client machine, the client machine operable to communicate event-specific program logic variables and display logic variables to the system operator machine over the one or more network servers.

Further embodiments, features, and advantages of the invention, as well as the structure and operation of the various embodiments of the invention are described in detail below with reference to the accompanying drawings.

### BRIEF DESCRIPTION OF DRAWINGS

Referring to the figures, wherein like numerals represent like parts throughout the several views:

FIG. 1 is a block diagram of a typical computer system into which one implementation of the present invention may be incorporated;

FIG. 2 is a block diagram of a typical system into which one implementation of the present invention may be incorporated;

FIG. 3 is a schematic block diagram showing the logic flow of a system and method for generating event-based metric aggregations;

FIG. 4 is a schematic block diagram of a routine executed during the logic flow of computing event-based metric aggregations;

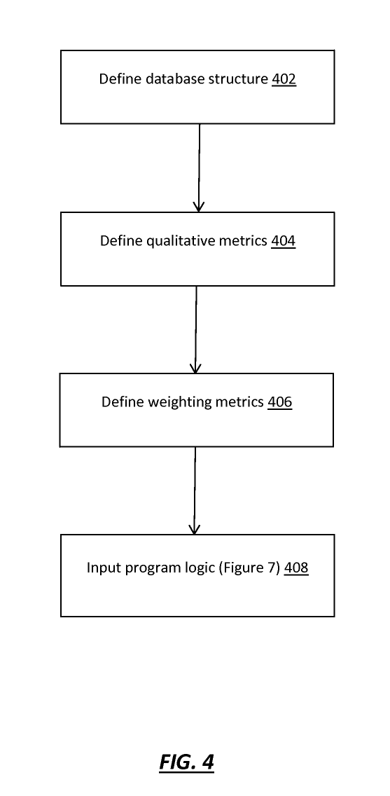

FIG. 5 is a schematic block diagram of a routine executed during the logic flow of computing event-based metric aggregations;

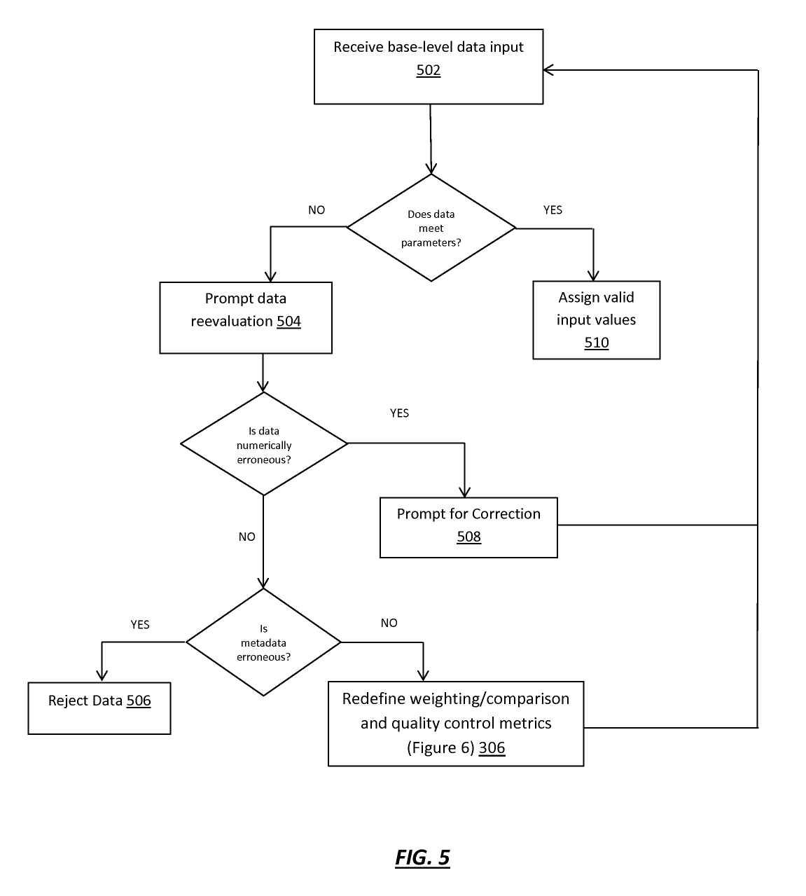

FIG. 6 is a schematic block diagram of a routine executed during the logic flow of computing event-based metric aggregations;

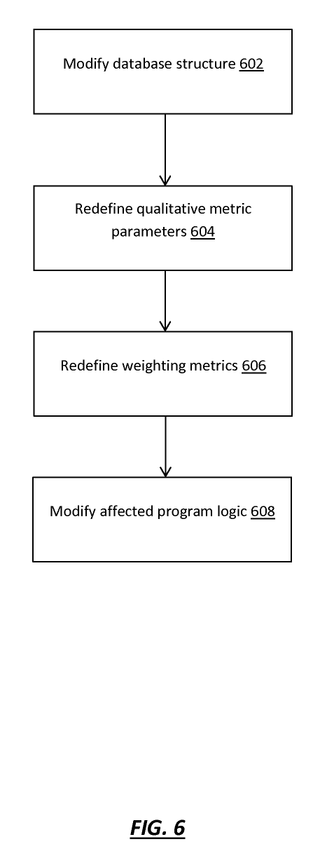

FIG. 7 is a schematic block diagram of a sub-routine executed during the logic flow of computing event-based metric aggregations;

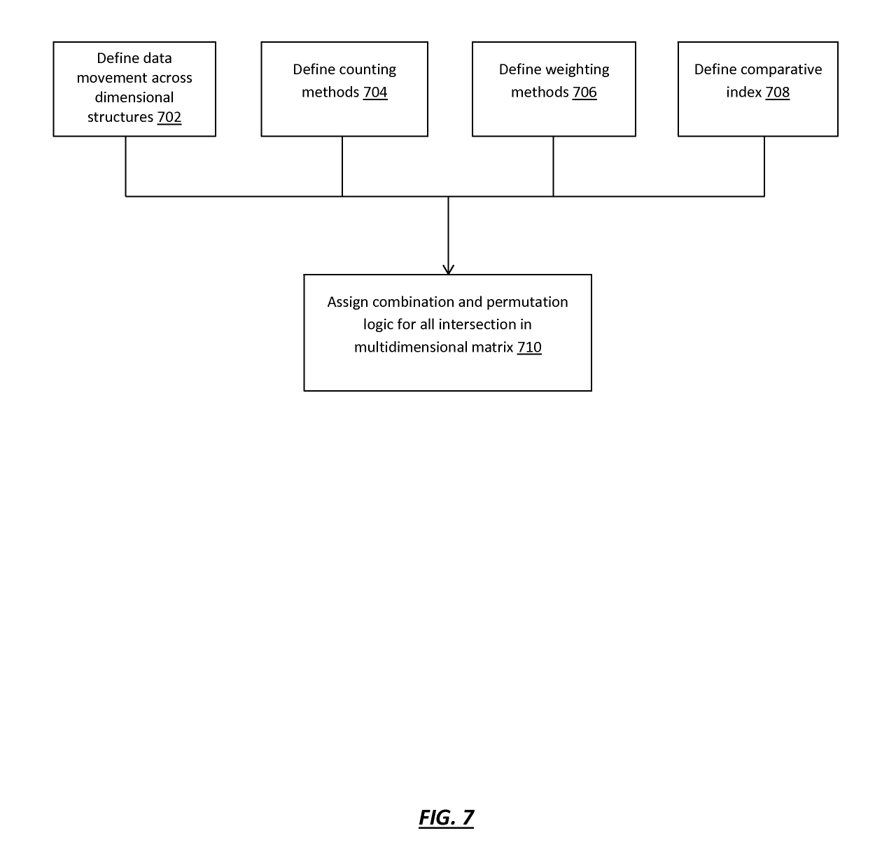

FIG. 8 is a schematic block diagram of a routine executed during the logic flow of computing event-based metric aggregations;

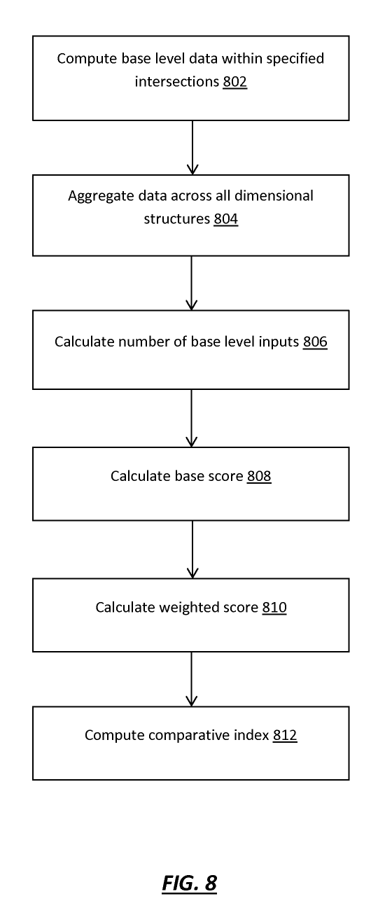

FIG. 9 is an illustrative example of a base level data input prompt that may be communicated by the system;

FIG. 10 is an illustrative example of dimensional structures that may be configured by the system;

FIG. 11 is an illustrative example of metric dimensions communicated by the system;

FIG. 12 is an illustrative example of event-specific dimensions communicated by the system; and,

FIG. 13 is an illustrative example of database aggregation trends communicated to a user machine by the system.

### DETAILED DESCRIPTION

Reference will now be made in detail to various embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of various embodiments of the present invention, numerous specific details are set forth in order to provide a thorough understanding of the present invention. In other instances, well-known methods, procedures, protocols, services, components, and circuits have not been described in detail so as not to unnecessarily obscure aspects of the present invention.

### Exemplary Computing Device

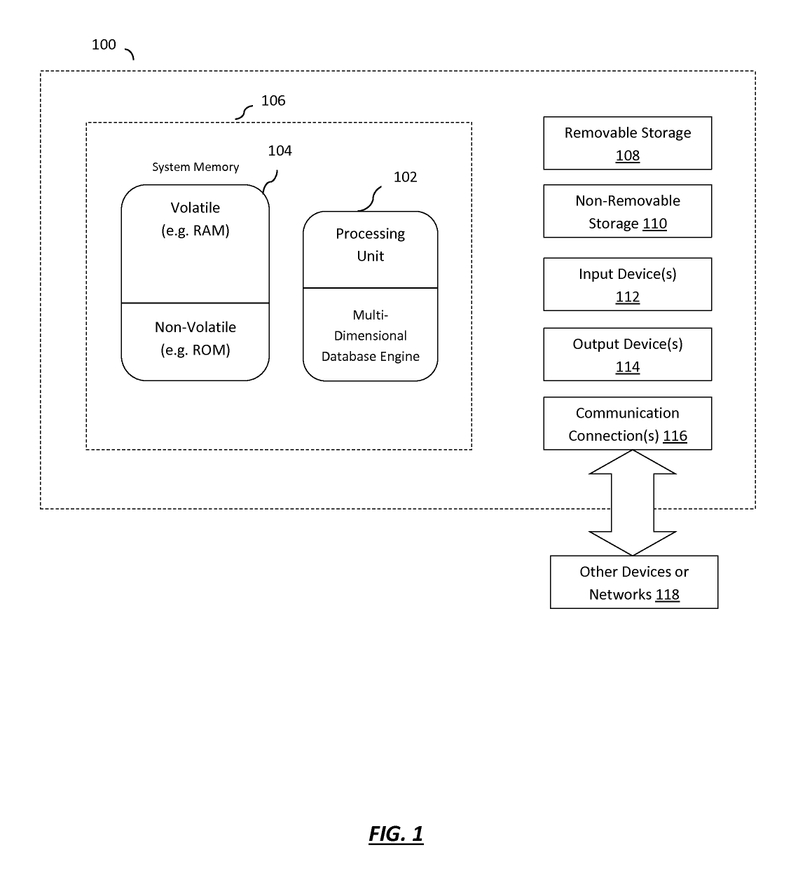

In an embodiment, FIG. 1 is a functional block diagram generally illustrating a computing device 100, one or more of which may be adapted for use in the illustrative system for implementing the invention. The computing device may be, for example, a personal computer, a handheld device such as a cell phone or tablet computer, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

In its most basic configuration, computing device 100 typically includes at least one processing unit which may be coupled to a multidimensional database (MDDB) engine 102 and system memory 104. Depending on the exact configuration and type of computing device, system memory 104 may be volatile (such as RAM), non-volatile (such as ROM, flash memory, etc.), or some combination of the two. The basic configuration of the device 100 is illustrated in FIG. 1 within the dashed line 106. Device 100 may function as a network server 206.

Device 100 may also have additional features and functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and non-volatile, removable and non-removable media implemented in any method or technology for storage of information such as computer readable instruction, data structures, program modules, or other data. System memory 104, removable storage 108, and non-removable storage 110 are examples of computer storage media. Computer storage media includes, but is not limited to RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be access by device 100. Any such computer storage media may be part of device 100.

Device 100 includes one or more input devices 112 such as a keyboard, mouse, pen, voice input device, touch input device, scanner, or the like. One or more output devices 114 may also be included, such as a video display, audio speakers, a printer, or the like. Input and output devices are well known in the art and need not be discussed at length here.

Device 100 also contains communications connection 116 that allows the device 100 to communicate with other devices 118, such as over a local or wide area network. Communications connection 116 is one example of communication media. Communication media includes any information delivery media that serves as a vehicle through which computer readable instructions, data structures, program modules, or other data may be delivered on a modulated data signal, such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, electromagnetic (e.g. radio frequency), infrared, and other wireless media. The term computer readable media as used herein includes both storage media and communication media.

### Distributed Computing Environments

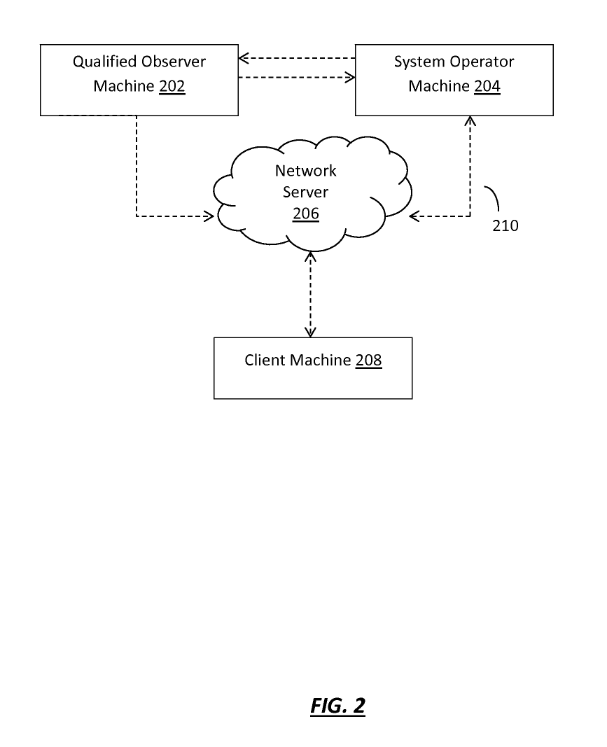

In an embodiment, FIG. 2 is a block diagram of a typical system into which one implementation of the present invention may be incorporated. In an embodiment, this system may function in a distributed computing environment through an on-line system, a private cloud interface, a public cloud interface, a hybrid cloud interface, or otherwise networked communication interface. A distributed computing environment may be defined as a computer networking scheme in which multiple software components are integrated to work closely toward well-developed objectives. These objectives may include building of custom applications or providing of support to other applications. In a distributed computing environment, program modules may be located in both local and remote memory storage devices. A public cloud may be defined as a cloud computing model, in which a service provider makes applications and storage available to the general public over the Internet. A private cloud may be defined as a proprietary network or data center that uses cloud computing technologies, such as virtualization, and may be managed by the organization it serves. A hybrid cloud may be defined as a cloud computing model that is maintained by both internal and external providers.

In an embodiment, a qualified observer machine 202 is operable to input base level data inputs through an input/output device. Qualified observer machine 202 may be of the same form and function as exemplary computing device 101. Qualified observer machine 202 may be coupled to a system operator machine 204 through wireless or wireline system networking 210, or may be hardwired as an integral part of the same computer system. Where qualified observer machine 202 is in communication with system operator machine 204 through a networked interface, wireless or wireline system networking 210 may function to deliver communication media across one or more network servers 206. Network server 206 may be of the same form and function as exemplary computing device 101. In this embodiment, system operator machine 204 may communicate base level input prompts to qualified observer machine 202 through wireless or wireline system networking 210 and/or one or more network servers 206. In an embodiment, base level input prompts may correspond to athletic event data points. These data points are in direct response to observations made by qualified observers, and are not generated by sensor-based detection. Base level input prompts may be in the form of Hypertext Markup Language (HTML) documents or other suitable documents that may be communicated over the Internet for display to qualified observer machine 202. The term “Web pages” encompasses HTML documents and any other appropriate techniques of displaying content using the Internet, such as Extensible Markup Language (XML) documents.

In an embodiment, client machine 208 is in communication with system operator machine 204 through a networked interface, wireless or wireline system networking 210 may function to deliver communication media across one or more network servers 206. Client machine 208 may be of the same form and function as exemplary computing device 101. Client machine 208 may query base level and derived information from system operator machine 204 through the use of one or more Web pages, or an intranet networked interface. Results from query aggregations, player performance, player index, and the like calculated on system operator machine 204, or on network server 206, may be displayed on a display device or output device on client machine 208.

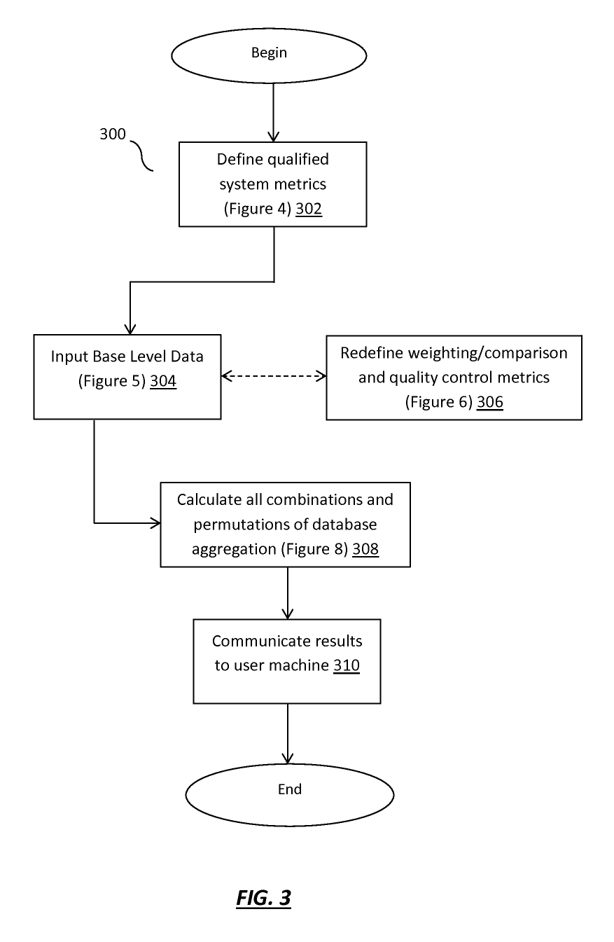

FIG. 3 is a schematic block diagram showing the logic flow of a system and method for generating event-based metric aggregations 300. System and method for generating event-based metric aggregations 300 may execute exclusively on system operator machine 204, or across a network interface with qualified observer machine 202 and client machine 208, as described in FIG. 2 above. An embodiment of system 300 takes in information (raw data) gathered from a sports activity. This information describes the performance on an event-by-event basis of an individual. The individual can be a participant in a team or independent sporting event that may or may not be scored from a competitive point of view. This play by play information may be broken down into different elements or components of performance and based on a best-case scenario. Manifestations of this scoring system may be based on a scale of 1 to 10, 1 to 100 or any other range of numeric values. The facts derived from this system are unique, in that, information calculated by this system does not exist before the system is implemented. The term “qualified observer” is meant to refer to any individual, party, entity, or combination thereof that inputs base level data derived from qualitative metric observations; and may be used interchangeably with “observer,” or “analyst.” The term “system operator” is meant to refer to any individual or entity that operates exemplary computing device 100 or qualified observer machine 204, and may be used interchangeably with “operator” or “user.” The term “client,” is meant to include any individual, party, entity, or combination thereof that queries base level data and derived information from system 300 or system operator machine 204, and may be used interchangeably with “user,” or “end-user.”

In an embodiment, system 300 functions to generate organized views or reports of user-specific information inquiries based on qualitative performance metrics of event-based data. This includes especially athletic events and sporting events. These metrics are dynamic and are continuously evolving based upon input by an end-user and a system operator. System 300 operates to express a qualitative view of event-specific data by continuously configuring program logic in response to dynamic system metrics 302. Qualified system metrics 302 may form the basis of aggregation logic and computation methodology executing in database engine 102. Defining qualified system metrics 302 may include the steps of defining a database structure 402, defining qualitative metrics 404, defining weighting metrics 406, and inputting program logic 408. Program logic 408 continuously changes for each event that is analyzed. Program logic metrics may be determined by end-user input and system operator input. Program logic is configured to assign combination and permutation logic values 710 in the multidimensional database engine 102, which may be executed independently or in tandem within network server 206 and/or system operator machine 204. Program logic determines how qualitative analysis is derived on an event-specific basis by defining data movement across dimensional structures 702, defining counting methods 704, defining weighting methods 706, and defining a comparative index 708. Database structure 402 may define dimensions within multidimensional database 102. Qualitative metrics 404 are unique to every event and every individual data set analyzed by the system. As a practical example, qualified system metrics 302 may include athletic data points and data sets. Using football as an example, defined data points may include Linebacker Pass/Rush, Linebacker Pass Coverage of Tight End, and Linebacker Pass Coverage of Wide Receiver and are generated through qualified observation of performance directly related to actual play. Using the same example, defined data sets may include Offense and Defense, with Linebacker as a subset of Defense. These data sets may be used to form the basis of metric dimensions, and hierarchical aggregations and calculations.

Upon defining system metrics 302, system 300 functions to input base level data 304. Base level data 304 is entered and stored in the multidimensional database engine 102 according to defined system metrics 302. System 300 is operable to reject a base level data input 304 if the input does not meet the parameters in defined system metrics 302, and assign valid input values 510 into multidimensional database engine 102 in response to a conforming base level data input. System 300 assigns valid input values 510 by first receiving a base level data input 502. Base level data input 502 is moved across database dimensional structures in accordance with qualified system metrics 302. If base level data input 502 meets system parameters, system 300 assigns valid input values 510 and stores values in multidimensional database engine 102. If base level data input 502 does not meet valid input parameters 510, system 300 prompts a data reevaluation 504. If data is erroneous, the system rejects the data 506 and excludes rejected data point from input value assignment. An example of erroneous data may include a data point that does not fall into a defined data set or dimensional structure. If data is numerically erroneous, e.g. a data point measures a value of 13 on a scale of 1 to 10, the system prompts for correction 508 and modified metric parameters are assigned to the base level data and the data is reevaluated 502. If the data satisfies the modified parameters, the data is assigned valid input values 510 and incorporated into the appropriate dimensional structure(s) within multidimensional database engine 102. If data is not numerically erroneous, system 300 evaluates the data to determine if it the metadata is erroneous. If the metadata is erroneous, the data is rejected 506. If the metadata is not erroneous, but is rather outside of the qualified system metrics 302, system 300 functions to redefine weighting/comparison methods and quality control metrics 306 and reevaluate the data.

In an embodiment, system 300 may redefine weighting/comparison methods and quality control metrics 306. Using football as an illustrative example, if the qualified system metrics 302 did not define values for how well a linebacker handles a double team, the system operator has the option to redefine 306 the metrics. This may occur by inputting a database structure modification 602 to multidimensional database 102. System 300 may then redefine the qualitative metric parameters 604 and weighting metrics 606, and modify the affected program logic as necessary. Redefinition 306 may not occur in every system execution, assuming no reconciliation events occur during data evaluation. Upon redefining the affected program logic 608, the system reevaluates the data 502 to assign valid input values 510.

In an embodiment, system 300 is operable to calculate all combinations and permutations of a multidimensional database aggregation 308, and communicate trend analysis and derived information to a user machine 310 in response to a user query. System 300 computes base level data within specified intersections 802 based on the combination and permutation logic 710. The base level data is then aggregated across all dimensional structures 804 through one or more processing units integrally configured to multidimensional database engine 102. The aggregation calculates the number of base level inputs 806, calculates a base score 808, calculates a weighted score 810, and computes a comparative index 812. These computations form the basis of dynamic analysis in response to an end-user request.

As an illustrative example of system 300 applied to a sporting event, the dimensions present in a manifestation of this system are initial and defined as “Time”, “Games” (or events), “Players” (or participants), and “Measures” (or metrics). The system 300 at a minimum will contain these dimensions, but is flexible enough to accommodate added dimensions and details when necessary. The time dimension as defined in system 300 can be made up of physical time elements such as years, quarters, months and days. The time dimension may allow analysis of players and how they perform during different time periods of the year and will also allow analysis during differing weather conditions and locations. The games (or events) dimensions allow the analysis of performance over different games. In some sports the events in which players perform is not called “games”, but may be referred to as matches, tests or rounds. System 300 may be continuously configured to handle a myriad of sports and any hierarchical structure which defines groups of these events and in whichever manner they are referred. The players (or participants) dimension describes every person that is involved in a sporting competition. The system is flexible enough to not only allow metrics on the different types of players, but could also be used in certain circumstances to maintain a constant set of metrics on coaches and/or assistant coaches. A common metric in these systems involves decision making strengths and weaknesses. This metrics dimension, in an embodiment metric parameters 402, describes the actual core metrics by which every other element of the data will be calculated. At its base, the measures dimension will contain information describing the performance of a participant at its lowest level (or event). At a higher, aggregate level, the metrics dimension provides the ability to see total scores for groupings of participants and the entire team. Because of the flexibility of the players dimension it is also possible to measure (against these same common metrics) the performance of participants that may be on different teams. It is also possible to perform metrics analysis in this way to see the participant performance of players jumping from one level of play to another (Triple AAA baseball to major leagues, or Nike tour to PGA tour).

The metrics dimension also allows the ability to view averaging of players or groups of players over many events across the other dimensions. For example, if a player being evaluated scores a 90 (on a scale of 1 to 100) in one event, and then scores a 70 in the next event. This score of 160 is not informative unless the scores can be averaged properly. A core component of this manifestation is the event counter, or number of qualified observations, which uniquely identifies the number of instances in which an individual was given the opportunity to record a score. In the above example, since two instances of a player having the opportunity to record a score were recorded, an instance counter would register a value of 2. In an embodiment, this could be implemented as a defined counting method 704. In this example, the score would be the sum of the two scores (90+70=160) divided by 2 (160/2=80). Further examples, such as football or basketball players, may have hundreds of instances to perform a certain type of play. A true median score can thus be derived showing a true performance metric of a player during the course of play of that game for that particular skill set or type of play. In the instance of a time dimension, the score may also be computed across the time dimensions and all other dimensions present in the system. In an embodiment, system 300 is operable to generate analyses of this metric data across time, across different games, across different teams all with the same metrics.

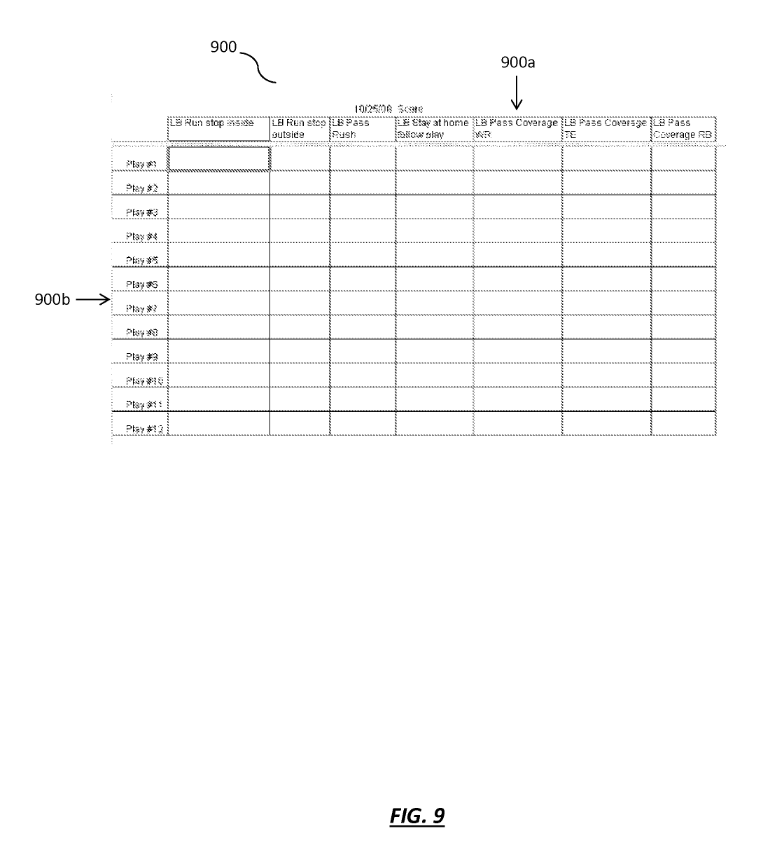

FIG. 9 is an illustrative example of a base level data input prompt that may be communicated by system 300. In an embodiment, display page 900 communicates two dimensions within a broader hierarchical structure representing system evaluation of a hypothetical football game. The two dimensions present in this illustration include metric dimension 900a and play dimension 900b. Metric dimension 900a allows the user to evaluate different qualitative metric dimensions across different play dimensions 900b within the overall context of a football game; and in the broader sense, within the overall context of a team, a season, a division, or an entire league.

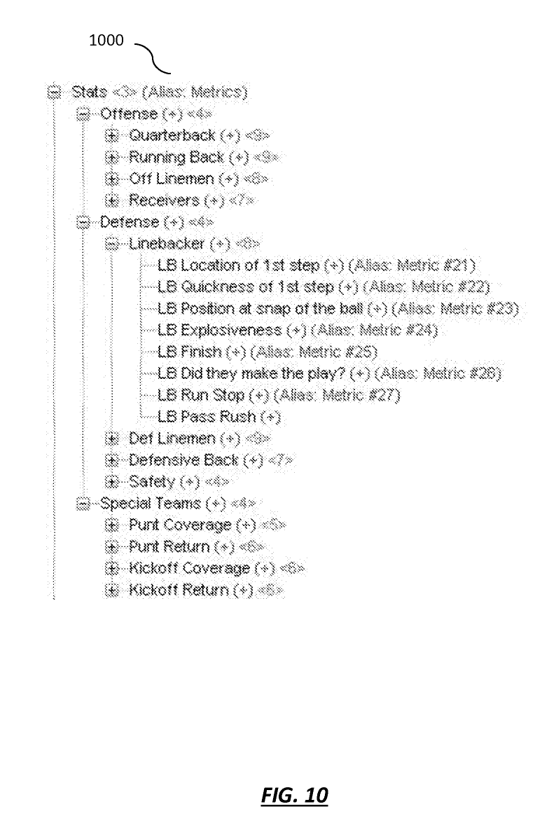

FIG. 10 is an illustrative example of hierarchical dimensional structures that may be configured by system 300. Hierarchical structures, such as a stats structure 1000, form the basis of data intersections across multiple dimensions in multidimensional database 102. These hierarchical structures are dynamic, and continuously evolve based on the defined metrics within the system logic, which may be configured by a system operator and/or an end user. As an illustrative example, stats structure 1000 show a system operator perspective of multiple dimensions and metrics within a hypothetical football game analysis by system 300. These dimensions may evolve based upon the qualified metrics definition. These definitions form the basis of scaled observations by a qualified observer, which ultimately form the basis of the combination and permutation logic.

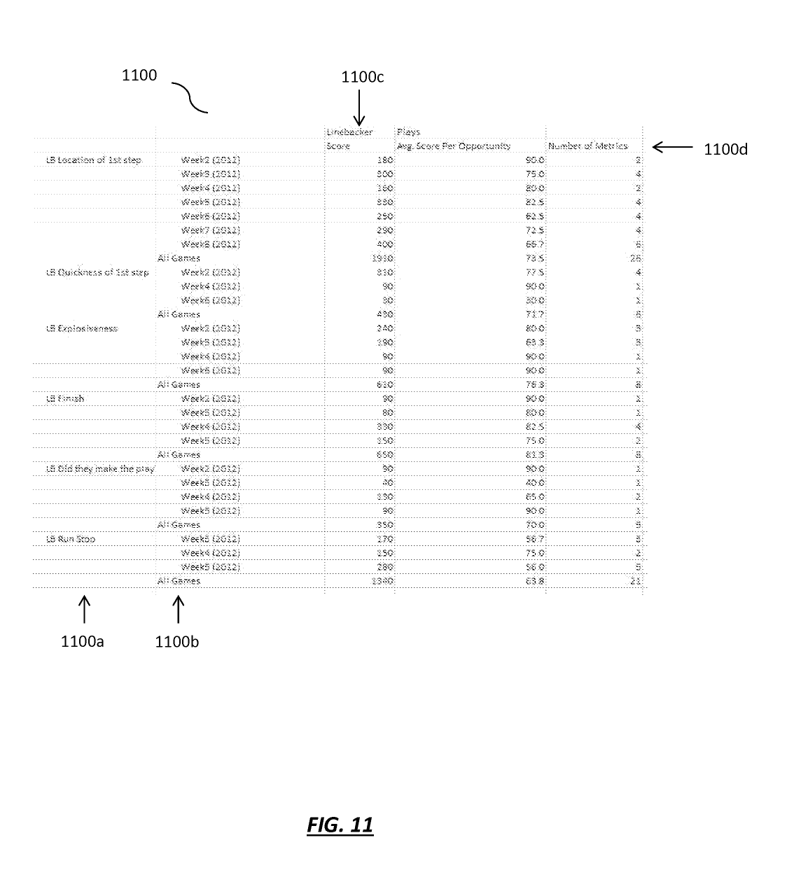

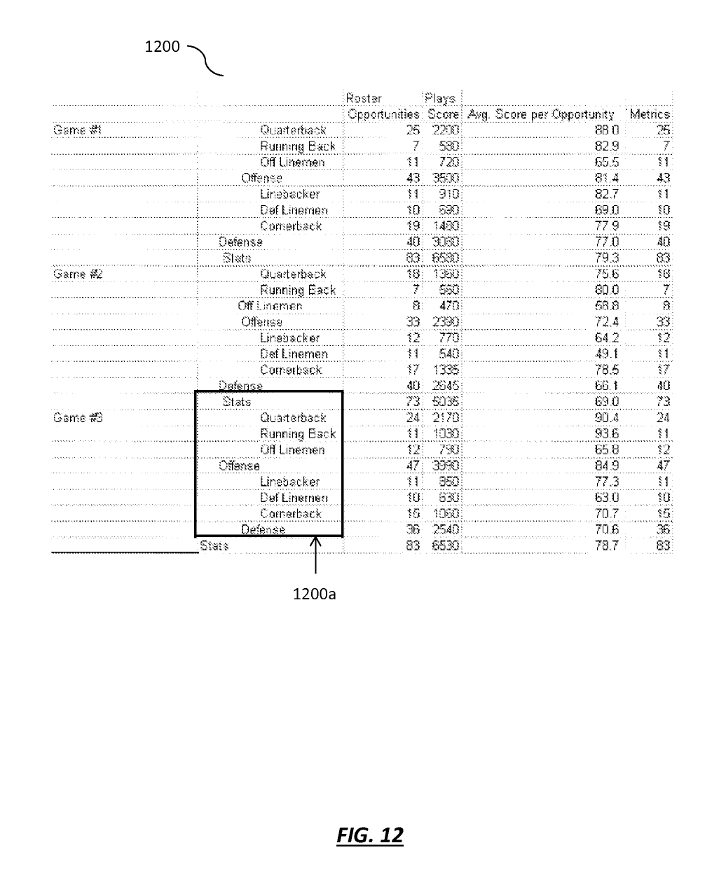

FIG. 11 is an illustrative example of metric dimensions configured in multidimensional database 102. Continuing the hypothetical football analysis, end-user perspective 1100 shows the intersection of qualitative observations across multiple dimensions within system 300. Qualitative metrics dimension 1100a may be viewed across a games/season dimension 1100b, a player dimension 1100c, and a calculation dimension 1100d. FIG. 12 is an illustrative example of event-specific dimensions communicated by system 300 to a client machine 208. End-user view 1200 demonstrates the placement of a stats hierarchy 1200a within a broader dimensional structure in multidimensional database 102. As discussed above, this stats hierarchy 1200a, and other illustrative hierarchies, is configured dynamically in response to user requirements and the classification of event observations.

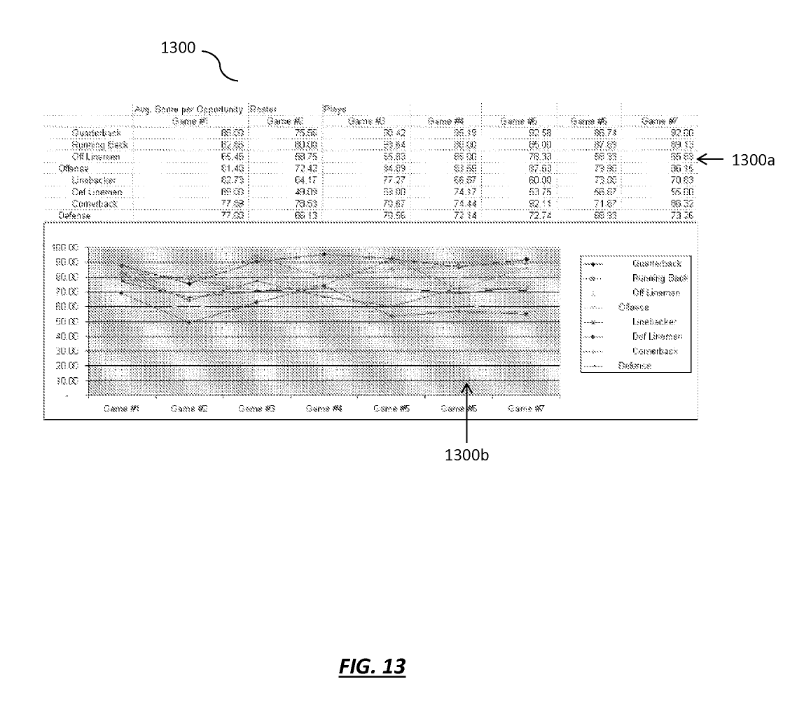

FIG. 13 is an illustrative example of database aggregation trends communicated to a client machine 208. In an embodiment, end-user view 1300 may display combination and permutation results across multiple dimensions and hierarchies. This can be display in a numerical perspective 1300a or a graphical perspective 1300b to evaluate performance trends over time and dimension.

Although the present invention has been described with several embodiments, numerous changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A computer-implemented method for expressing qualitative, dynamic event-based performance analysis comprising:
defining qualified system metrics, the qualified system metrics being stored in a multi-dimensional database and incorporated into a calculation algorithm executing on one or more microprocessors;
inputting base level data into at least one input page using an input/output device, the base level data being stored in the multi-dimensional database;
inputting weighting and comparison metrics, and quality control metrics, into at least one input page using an input/output device, the weighting and comparison metrics, and the quality control metrics being stored in the multi-dimensional database;
aggregating the base level data and the weighting and comparison metrics and quality control metrics executing on the one or more microprocessors and in communication with the multi-dimensional database; and,
calculating all combinations and permutations of the base level data and the weighting and comparison metrics and quality control metrics executing on the one or more microprocessors and in communication with the multi-dimensional database.

2. The method of claim 1 further comprising displaying the combinations and permutations in accordance with identified display variables on at least one display device.

3. The method of claim 1 further comprising displaying the combinations and permutations in accordance with identified display variables on one or more Web pages.

4. The method of claim 1 further comprising:
evaluating the base level data input against the qualified system metrics stored in the multi-dimensional database;
determining data conformance with the qualified system metrics executing on the one or more microprocessors; and,
assigning valid input values in response to a conforming base level data input, the valid input values being stored in the multi-dimensional database.

5. The method of claim 1 wherein variables for the calculation algorithm are assigned in the multi-dimensional database in response to a request received from an end-user through at least one networked device.

6. The method of claim 1 further comprising defining program logic executing on the one or more microprocessors in response to a qualitative metric input through an input/output device.

7. The method of claim 2 further comprising assigning display variable values in response to an end-user input through at least one networked device.

8. The method of claim 6 further comprising computing the base level data within specified intersections based upon the defined program logic executing on the one or more microprocessors.

9. The method of claim 8 further comprising computing a comparative index based upon a weighted score calculated on the one or more microprocessors in response to the base level data within the specified intersections and the defined program logic.

10. A system for generating qualitative event-based performance analysis comprising:
a system operator machine, the system operator machine being operable to generate and store qualitative event parameters in response to an end user request;
a qualified observer machine, the qualified observer machine being operable to receive qualitative event parameters from the system operator machine over one or more network servers, and communicate base level data to the system operator machine through the one or more network servers; and,
a client machine, the client machine being operable to communicate qualitative variables and display variables to the system operator machine over the one or more network servers.

11. The system of claim 10 wherein the system operator machine is further operable to store the event parameters communicated by the qualified observer machine within specified intersections across a multi-dimensional database, and aggregate data across predetermined dimensional structures through the use of one or more microprocessors.

12. The system of claim 10 wherein the system operator machine is further operable to assign valid input values to base level data in response to a conforming qualitative parameter, the conforming qualitative parameter entered as program logic through an input/output device in communication with the system operator machine.

13. The system of claim 11 wherein the system operator machine is further operable to aggregate data according to defined counting parameters, weighting parameters, and comparative index parameters, the counting parameters, weighting parameters, and comparative index parameters defined by a user input and stored in the multi-dimensional database.

14. The system of claim 13 wherein the system operator machine is further operable to dynamically generate a comparative index according to aggregated data and qualitative metrics.

15. The system of claim 14 wherein the system operator machine communicates a comparative index display to a client machine over the one or more network servers.

16. A system for generating qualitative analysis of athletic events comprising:
a system operator machine, the system operator machine operable to execute event-specific program logic on one or more microprocessors;
a qualified observer machine, the qualified observer machine operable to input base level data according to predetermined parameters over one or more network servers to a multi-dimensional database; and,
a client machine, the client machine operable to communicate event-specific program logic variables and display logic variables to the system operator machine over the one or more network servers.

17. The system of claim 16 wherein the system operator machine is operable to define the multi-dimensional database structure in response to a qualitative input parameter.

18. The system of claim 16 wherein the system operator machine is operable to compute a comparative index of event-specific data across defined performance metrics executing on the one or more microprocessors.

19. The system of claim 17 wherein the system operator machine is operable to aggregate the base level data across the multi-dimensional database structure across one or more network servers.

20. The system of claim 19 wherein the system operator machine is operable to calculate all combinations and permutations of data and calculations across the multi-dimensional database structure across one or more network servers.
